(19) United States
(12) Patent Application Publication
(10) Pub. No.: US 2020/0319045 A1
(43) Pub. Date: Oct. 8, 2020

(54) BRAKE INSPECTION APPARATUS AND NUMERICAL CONTROL APPARATUS FOR INSPECTING BRAKE DEVICE

(71) Applicant: FANUC CORPORATION, Yamanashi (JP)

(72) Inventor: Hiroshi KOBAYASHI, Yamanashi (JP)

(21) Appl. No.: 16/831,809

(22) Filed: Mar. 27, 2020

(30) Foreign Application Priority Data
Apr. 3, 2019 (JP) 2019-071427

(51) Int. Cl. G01L 5/28; G01L 3/18; G01P 3/44; G01B 7/30; B26D 3/08

(52) U.S. Cl. CPC G01L 5/28; G01L 3/18; B26D 3/08; G01B 7/30; G01P 3/44

(57) ABSTRACT

A brake inspection apparatus for inspecting a brake device includes a command unit configured to, in an inspection mode, command the brake device to brake a motor, and further command a motor current supply unit to gradually increase a motor current supplied to the motor by a predetermined step size, a brake torque measurement unit configured to measure a brake torque immediately before the motor starts to rotate, when the motor current is gradually increased based on a command from the command unit, and a brake torque drop curve calculation unit configured to calculate a brake torque drop curve representing the relationship between the operating time and the brake torque, based on brake torques measured by the brake torque measurement unit in inspection modes set for different periods.

### BACKGROUND OF THE INVENTION

### 1. Field of the Invention

The present invention relates to a brake inspection apparatus and a numerical control apparatus for inspecting a brake device.

### 2. Description of the Related Art

In, e.g., a motor drive apparatus for driving a motor in a machine such as an industrial robot or a machine tool, a mechanical brake device (to be sometimes simply referred to as a “brake device” hereinafter) that performs braking by a friction force is widely used to brake the motor or fix the motor so as to keep it from rotating. In such a brake device, a friction plate is interposed between an armature and an end plate, and the motor is braked by pressing, by the elastic force of a spring, the armature against the friction plate connected to a motor shaft, and braking on the motor is cancelled by separating the armature from the friction plate by an electromagnetic force generated by supplying a brake coil current to a brake coil.

As disclosed in, e.g., Japanese Unexamined Patent Publication No. 2005-54843, a brake device including a brake unit that brakes a motor or a machine using the motor, a brake control unit that controls the brake unit, and a brake state monitoring unit is known to supply a lock signal to the brake unit by the brake control unit, monitor a state signal of the motor fed back from the motor by the brake state monitoring unit, estimate a brake state based on the state signal of the motor, and issue a warning or an alarm when an abnormality is detected.

As disclosed in, e.g., Japanese Unexamined Patent Publication No. H9-30750, a brake characteristic evaluation apparatus for an elevator including a sheave around which a main rope that suspends a car and a counterweight is wound, a motor that vertically moves the car by driving the sheave, a drum brake that applies a braking force to a rotating shaft of the motor by bringing a brake shoe into press contact with a brake drum by an elastic force of a braking spring, and a controller that controls a rotation operation of the motor and a braking operation of the drum brake is known to include a speed detection means for detecting a speed of the elevator, a maintenance moving operation means for performing a maintenance moving operation for moving the elevator at a predetermined speed, and then stopping the elevator by applying the braking force to the rotating shaft of the motor by actuating the drum brake, a speed storage means for storing, as needed, the speed of the elevator detected by the speed detection means, while the elevator performs the maintenance moving operation by the maintenance moving operation means, a deceleration calculation means for reading the speed of the elevator stored in the speed storage means, and calculating a derivative of the speed, i.e., a deceleration, a change point detection means for detecting change points of the deceleration calculated by the deceleration calculation means, and a brake characteristic evaluation means for evaluating a brake characteristic of the elevator by comparing a value of a time interval between the change points of the deceleration detected by the change point detection means or a value of the deceleration calculated by the deceleration calculation means with a preset standard value.

As disclosed in, e.g., Japanese Unexamined Patent Publication No. 2012-55981, a robot control apparatus for controlling a robot including a servomotor, an angle sensor that detects a rotation angle of the servomotor, and a mechanical brake for stopping the servomotor is known to include a drive control unit that obtains the rotation angle from the angle sensor and performs feedback control of driving of the servomotor in accordance with the obtained rotation angle, an estimation unit that estimates a rotation speed of the servomotor, based on an electrical variable of the servomotor, an abnormality detection unit that detects an abnormality of the angle sensor, a dynamic brake control unit that controls actuation of a dynamic brake for the servomotor, and an abnormal stop control unit that, when the abnormality of the angle sensor is detected, performs first braking processing for actuating the dynamic brake without actuating the mechanical brake if a torque sum of a braking torque generated by the dynamic brake assuming that the dynamic brake is actuated at the estimated rotation speed and a braking torque generated by the mechanical brake assuming that the mechanical brake is actuated is higher than a predetermined torque upper limit, and performs second braking processing for actuating the dynamic brake and the mechanical brake if the torque sum is equal to or lower than the torque upper limit.

As disclosed in, e.g., Japanese Unexamined Patent Publication No. 2012-135087, a motor control apparatus is known to include a speed regulator that generates a torque current command based on a rotation speed command signal and a rotation speed detection signal of an AC motor, a torque current regulator that controls a torque current supplied to the AC motor, based on the generated torque current command, a torque current conversion gain unit that calculates an estimated torque current based on the torque current command, an acceleration/deceleration current conversion gain unit that calculates an estimated acceleration/deceleration torque current based on the rotation speed detection signal of the AC motor, a disturbance load torque observer gain unit that generates an estimated disturbance load torque current command by filtering an estimated disturbance load torque current, calculated by subtracting the estimated acceleration/deceleration torque current from the estimated torque current, and multiplying the estimated disturbance load torque current by a disturbance load torque current command conversion gain, and a limiter that limits a rate of change in output of the disturbance load torque observer gain unit, wherein the disturbance load torque observer gain unit output limited by the limiter is added to the torque command.

### SUMMARY OF INVENTION

In the mechanical brake device that performs braking by a friction force, since the motor is braked by pressing the armature against the friction plate, the armature and the friction plate gradually wear and the brake torque of the motor then drops, upon the elapse of the operating time of the brake device (with an increase in number of operations), and the armature and the friction plate finally come to the ends of their lives.

When the brake device whose brake torque has dropped to be as low as a lower limit or less, which serves as a criterion for ensuring a certain brake performance, is continuously used as it is, a machine such as an industrial robot or a machine tool equipped with the brake device may stop, a failure may occur in a product manufactured by the machine, or a more serious accident may occur. In addition, a protection circuit for the machine equipped with the brake device may act to perform an alarm stop (emergency stop) of the machine. Such an alarm stop may even involve emergency repair work and lead to a decrease in operating rate of the machine. Accordingly, to allow prevention of a sudden alarm stop, a demand has arisen for a technique capable of obtaining information on the tendency of the brake torque to drop.

The use environment of the brake device significantly affects the brake torque as well. The brake torque also drops when, for example, a foreign substance enters the gap between the armature and the friction plate or that between the end plate and the friction plate in the brake device. As a specific example, in a brake device for stopping a motor mounted in a cutting machine, a cutting fluid may enter the gap between the armature and the friction plate or that between the end plate and the friction plate, and the brake torque may then drop. In this manner, since the brake torque may drop due to factors other than wear of the armature, the friction plate, and the end plate, it is difficult to obtain information on the tendency of the brake torque of the brake device to drop.

A demand has thus arisen for a brake inspection apparatus capable of precisely and easily obtaining information on the tendency of the brake torque of a mechanical brake device, which performs braking by a friction force, to drop.

According to one aspect of the present disclosure, a brake inspection apparatus for inspecting a brake device that brakes a motor by pressing, by an elastic force of a spring, an armature against a friction plate connected to a motor shaft, and cancels braking on the motor by separating the armature from the friction plate by an electromagnetic force generated by supplying a brake coil current to a brake coil includes a command unit configured to, in an inspection mode, command the brake device to brake the motor, and further command a motor current supply unit to gradually increase a motor current supplied to the motor by a predetermined step size, a brake torque measurement unit configured to measure a brake torque immediately before the motor starts to rotate, when the motor current supplied from the motor current supply unit is gradually increased based on a command from the command unit, and a brake torque drop curve calculation unit configured to calculate a brake torque drop curve representing a relationship between the brake torque and an operating time of the brake device, based on a plurality of brake torques measured by the brake torque measurement unit in a plurality of inspection modes set for different periods.

According to another aspect of the present disclosure, a numerical control apparatus for a machine tool includes the above-mentioned brake inspection apparatus.

### BRIEF DESCRIPTION OF THE DRAWINGS

The present invention will be more clearly understood with reference to the following accompanying drawings:

FIG. 1 is a schematic block diagram depicting the configuration of a brake inspection apparatus and a numerical control apparatus according to one embodiment of the present disclosure;

FIGS. 2A and 2B are sectional views depicting the structure of a mechanical brake device that performs braking by a friction force;

FIG. 3 is a flowchart depicting the operation sequence of the brake inspection apparatus according to the embodiment of the present disclosure;

FIG. 4 is a graph for explaining brake torque drop curve calculation processing by a brake torque drop curve calculation unit and life estimation processing by a life estimation unit in the embodiment of the present disclosure;

FIG. 5 is a graph for explaining brake torque drop curve calculation processing by the brake torque drop curve calculation unit and life estimation processing by the life estimation unit, which take into consideration the amount of entrance of a cutting fluid for a cutting machine into the brake device, in the embodiment of the present disclosure;

FIG. 6A is a graph illustrating an exemplary deterioration of a seal mounted in a housing, when the seal does not deteriorate;

FIG. 6B is a graph illustrating another exemplary deterioration of a seal mounted in a housing, when the seal is broken at time t₅;

FIG. 6C is a graph illustrating still another exemplary deterioration of a seal mounted in a housing, when the seal starts to gradually deteriorate at time t₆ and is completely broken at time t₇;

FIG. 6D is a graph illustrating still another exemplary deterioration of a seal mounted in a housing, when the seal starts to gradually deteriorate immediately after the start of use of the housing as newly manufactured, and is completely broken at time t₈;

FIG. 6E is a graph illustrating still another exemplary deterioration of a seal mounted in a housing, when the housing as newly manufactured exhibits no seal performance from the beginning; and

FIG. 7 is a graph for explaining brake torque drop curve calculation processing by the brake torque drop curve calculation unit and life estimation processing by the life estimation unit, which take into consideration the seal performance of a housing accommodating the brake device, in the embodiment of the present disclosure.

### DETAILED DESCRIPTION

A brake inspection apparatus and a numerical control apparatus for inspecting a mechanical brake device that performs braking by a friction force will be described below with reference to the drawings. These drawings use different scales as appropriate to facilitate an understanding. The mode illustrated in each drawing is one example for carrying out the present disclosure, and the present disclosure is not limited to the embodiments illustrated in these drawings.

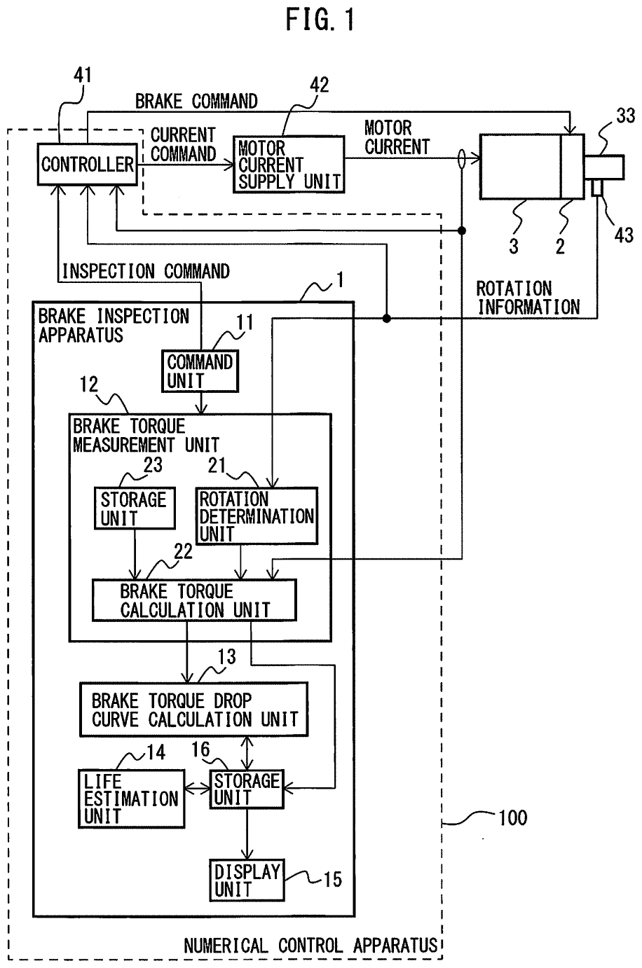

FIG. 1 is a schematic block diagram depicting the configuration of a brake inspection apparatus and a numerical control apparatus according to one embodiment of the present disclosure.

The case where a brake device 2 is mounted on a motor 3 connected to a motor current supply unit 42 will be taken as an example below. The motor current supply unit 42 outputs a motor current for driving the motor 3, based on a current command received from a controller 41. The controller 41 generates a current command, based on, e.g., the motor current output from the motor current supply unit 42, rotation information of the motor 3 detected by a sensor 43 mounted on the motor 3, a torque command for the motor 3, and an operation program defined in advance. The motor current supply unit 42 supplies, to the motor 3, a motor current corresponding to the current command generated by the controller 41. With this operation, the motor 3 has its speed, torque, or rotor position controlled based on the motor current supplied from the motor current supply unit 42. The operation of the controller 41 may be defined, including terms such as a torque command, a position command, a speed command, and an angle command.

Examples of machines equipped with the motor 3 include a robot and a machine tool. Referring to FIG. 1, as an example, a machine tool is used as the machine equipped with the motor 3, and the controller 41 is placed in a numerical control apparatus 100 for the machine tool.

The type of motor 3 is not particularly limited, and may be implemented as, e.g., an AC motor or a DC motor. When the motor 3 is implemented as an AC motor, it may serve as, e.g., an induction motor or a synchronous motor. When the motor 3 is implemented as an AC motor, the motor current supply unit 42 includes, e.g., a rectifier that converts AC power supplied from an AC power supply into DC power, and an inverter (amplifier) that converts the DC power into AC power and supplies AC drive power to the motor 3. As another example, the motor current supply unit 42 serves as an inverter (amplifier) that converts DC power supplied from a DC power supply such as a battery into AC power and supplies AC drive power to the motor 3. When the motor 3 is implemented as a DC motor, the motor current supply unit 42 serves as, e.g., a rectifier that converts AC power supplied from an AC power supply into DC power and supplies a DC drive current to the motor 3, or a DC/DC converter that converts a DC voltage applied from a DC power supply such as a battery into an appropriate DC voltage and supplies a DC drive current to the motor 3.

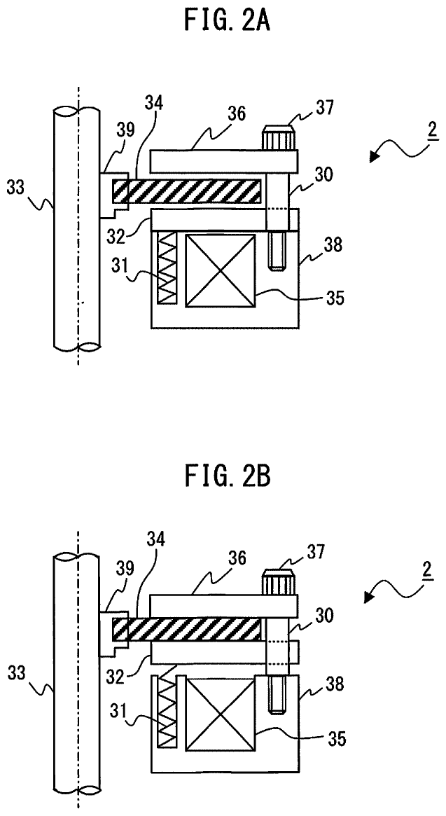

Before a description of a brake inspection apparatus 1 and a numerical control apparatus 100 according to one embodiment of the present disclosure, the structure of the brake device 2 will be described below with reference to FIGS. 2A and 2B. FIGS. 2A and 2B are sectional views depicting the structure of a mechanical brake device that performs braking by a friction force.

In the brake device 2, a friction plate 34 is interposed between an armature 32 and an end plate 36, as illustrated in FIGS. 2A and 2B. Since a hub 39 is splined to the friction plate 34, and the hub 39 and a motor shaft 33 are integrated with each other by shrink fitting, the friction plate 34 rotates by interlocking with rotation of the motor shaft 33. The end plate 36 and a spacer 30 are connected to each other by a bolt 37, and the armature 32 is connected to the spacer 30 to be movable in directions coming close to and going away from the friction plate 34. A spring 31 and a brake coil 35 are placed in a core 38. With no brake coil current flowing through the brake coil 35, since the armature 32 is tightly pressed against the friction plate 34 by the elastic force of the spring 31, the friction plate 34 may not rotate as sandwiched between the armature 32 and the end plate 36, as illustrated in FIG. 2B. As a result, since the motor shaft 33 connected to the friction plate 34 may not rotate either, the motor 3 is braked. When a brake coil current is supplied to the brake coil 35, an electromagnetic force stronger than the elastic force of the spring 31 pressing the armature 32 against the friction plate 34 occurs in the core 38, and the armature 32 is thus attracted to the core 38 to release the friction plate 34 from contact with the armature 32 and the end plate 36, as illustrated in FIG. 2A. As a result, since the friction plate 34 and, by extension, the motor shaft 33 can freely rotate, braking on the motor 3 is canceled. A brake power supply device (not illustrated) for outputting a brake coil current is connected to the brake coil 35. No brake coil current is output from the brake power supply device when a brake command output from the controller 41 commands the brake device 2 to perform braking, and a brake coil current is output from the brake power supply device to the brake coil when a brake command output from the controller 41 commands the brake device 2 to cancel braking.

In this manner, in a normal operation mode, the brake device 2 brakes the motor 3 by supplying no brake coil current to the brake coil 35 and cancels braking on the motor 3 by supplying a brake coil current to the brake coil 35, based on brake commands output from the controller 41. Braking is performed by friction between the friction plate 34 and each of the armature 32 and the end plate 36, so the friction plate 34, the armature 32, and the end plate 36 wear for every braking and the brake torque drops as a result upon the elapse of the operating time of the brake device 2 (with an increase in number of operations). The state in which the brake torque has dropped to be as low as a lower limit or less, which serves as a criterion for ensuring a certain brake performance, is generally recognized as the “state in which the brake device has come to the end of its life,” or the “state in which the brake device has broken down.” The brake inspection apparatus 1 according to the embodiment of the present disclosure can precisely and easily obtain information on the tendency of the brake torque of the brake device 2 to drop, and estimate the period in which the brake device 2 comes to the end of its life.

The brake inspection apparatus 1 according to the embodiment of the present disclosure conducts brake inspection for the brake device 2 in an inspection mode different from the normal operation mode of the brake device 2. To calculate a brake torque drop curve by a brake torque drop curve calculation unit 13 (to be described later), since the values of brake torques measured during different periods may be preferably used, an inspection mode is set a plurality of times for different periods. The period in which an inspection mode is set can be freely set. An inspection mode, for example, may be set on a specific date and time, may be set at an arbitrary time interval, may be set before the start of a specific operation of the machine equipped with the brake device 2, or may be set after the completion of a specific operation of the machine equipped with the brake device 2. In these cases, when the period of the set inspection mode comes, the brake inspection apparatus 1 may automatically start brake inspection for the brake device 2. As another example, the brake inspection apparatus 1 may start its operation in response to a brake inspection start operation by the operator. To start the operation of the brake inspection apparatus 1 in response to a brake inspection start operation by the operator, the brake inspection apparatus 1 or the numerical control apparatus 100 equipped with the brake inspection apparatus 1, for example, may be equipped with a switch (either a hardware switch or a software switch displayed on a display may be used) for issuing a brake inspection start instruction.

The brake inspection apparatus 1 according to the embodiment of the present disclosure includes a command unit 11, a brake torque measurement unit 12, and a brake torque drop curve calculation unit 13, as illustrated in FIG. 1. The brake inspection apparatus 1 further includes a life estimation unit 14, a display unit 15, and a storage unit 16.

In an inspection mode different from the normal operation mode of the brake device 2, the command unit 11 commands the brake device 2 to brake the motor 3, and further commands the motor current supply unit 42 to gradually increase the motor current supplied to the motor 3 by a predetermined step size. Since the controller 41 controls both the brake operation by the brake device 2 and the motor current output operation by the motor current supply unit 42, each command issued by the command unit 11 in the inspection mode is sent to the controller 41 as an inspection command.

In response to the inspection command from the command unit 11, the controller 41 controls the brake device 2 to brake the motor 3. More specifically, the controller 41 performs control to output no brake coil current from the brake power supply device. With this operation, no brake coil current flows through the brake coil 35 of the brake device 2, the armature 32 of the brake device 2 is tightly pressed against the friction plate 34 by the elastic force of the spring 31, and the friction plate 34 may not rotate as sandwiched between the armature 32 and the end plate 36. As a result, since the motor shaft 33 connected to the friction plate 34 may not rotate either, the motor 3 is braked.

In response to the inspection command from the command unit 11, the controller 41 further controls the motor current supply unit 42 to gradually increase the motor current supplied to the motor 3 by a predetermined step size. The step size may be preferably set to, e.g., several milliamperes to several hundred milliamperes, but it can be freely set. The controller 41 generates a current command to gradually increase the output motor current by a predetermined step size, and transmits it to the motor current supply unit 42. The motor current supply unit 42 supplies, to the motor 3, a motor current corresponding to the current command generated by the controller 41. Since the controller 41 generates a current command based on, e.g., a torque command, a position command, a speed command, and an angle command, the motor current output from the motor current supply unit 42 may be controlled to gradually increase by a predetermined step size, by adjusting any of these commands.

In this manner, in the example illustrated in FIG. 1, the inspection commands issued by the command unit 11 in the inspection mode are sent to the controller 41, which controls the brake device 2 and the motor current supply unit 42 in response to these inspection commands. As an alternative example, the above-mentioned operations of the brake device 2 and the motor current supply unit 42 in the inspection mode may be directly controlled by directly sending each inspection command issued by the command unit 11 in the inspection mode to a corresponding one of the motor current supply unit 42 and the brake device 2.

The brake torque measurement unit 12 measures a brake torque immediately before the motor 3 starts to rotate, when the motor current supplied from the motor current supply unit 42 is gradually increased based on the command from the command unit 11. In the inspection mode, as described above, the motor 3 has been braked as the friction plate 34 of the brake device 2 is sandwiched between the armature 32 and the end plate 36. When the motor current supplied from the motor current supply unit 42 is gradually increased based on the command from the command unit 11, the static friction force between the friction plate 34 and each of the armature 32 and the end plate 36 gradually strengthens, and when this force exceeds a maximum static friction force, the friction plate 34 starts to move relative to the armature 32 and the end plate 36, and the motor 3 thus starts to rotate. The torque takes a maximum value immediately before the motor 3 starts to rotate, and the torque maximum value is assumed as the brake torque of the brake device 2 and measured by the brake torque measurement unit 12 in this embodiment.

The brake torque measurement unit 12 includes a rotation determination unit 21, a brake torque calculation unit 22, and a storage unit 23.

The rotation determination unit 21 determines whether the motor 3 has rotated, every time the motor current supplied form the motor current supply unit 42 is increased by a predetermined step size, based on the command from the command unit 11 in the inspection mode. It is determined whether the motor 3 has rotated, based on rotation information of the motor 3 detected by the sensor 43. The rotation information of the motor 3 includes, e.g., the rotor rotation angle (position) and the rotation speed of the motor 3. Assuming, for example, that the rotation speed of the motor 3 is used as the rotation information of the motor 3, the rotation determination unit 21 determines that “the motor 3 has rotated” when the rotation speed of the motor 3 detected by the sensor 43 exceeds a rotation speed threshold specified in advance. Assuming, for example, that the rotor rotation angle of the motor 3 is used as the rotation information of the motor 3, the rotation determination unit 21 determines that “the motor 3 has rotated” when the rotation angle of the motor 3 detected by the sensor 43 exceeds a rotation angle threshold specified in advance. It is determined whether the motor 3 has rotated, based on a comparison between the threshold and the rotation information of the motor 3 detected by the sensor 43 in this manner, to eliminate erroneous determination of the rotation determination unit 21 due to an error included in the rotation information detected by the sensor 43. The threshold compared with the rotation information of the motor 3 may be preferably set as appropriate, based on, e.g., the rotation information detected by the sensor 43 and the actual rotation state of the motor 3, by conducting a test operation of the motor 3.

The storage unit 23 stores a torque constant K_{T} used to calculate a brake torque. As the torque constant K_{T}, a value specified in the specification of the motor 3 in advance, for example, may be preferably used. The storage unit 23 is implemented as, e.g., an electrically erasable and recordable nonvolatile memory such as an EEPROM®, or a high-speed readable and writable random access memory such as a DRAM or an SRAM.

The brake torque calculation unit 22 calculates a brake torque, based on the torque constant of the motor 3, and the difference of at least the step size subtracted from the value of the motor current supplied from the motor current supply unit 42 when the rotation determination unit 21 determines for the first time that the motor 3 has rotated. The brake torque calculated using the “difference of at least the step size subtracted from the value of the motor current when it is determined for the first time that the motor 3 has rotated” in this manner is used as the brake torque immediately before the motor 3 starts to rotate, for the following reason.

In the inspection mode, every time the motor current supplied from the motor current supply unit 42 to the motor 3 is increased by a predetermined step size, the rotation determination unit 21 determines whether the motor 3 has rotated. While the motor current supplied from the motor current supply unit 42 to the motor 3 stays low, the motor 3 does not rotate because the friction force between the friction plate 34 and each of the armature 32 and the end plate 36 is stronger than the rotation force of the motor 3 based on the motor current, and the rotation determination unit 21 therefore does not determine that the motor 3 has rotated. When the motor current supplied from the motor current supply unit 42 to the motor 3 is gradually increased and exceeds a certain magnitude, since the rotation force of the motor 3 based on the motor current becomes stronger than the friction force between the friction plate 34 and each of the armature 32 and the end plate 36, the friction plate 34 connected to the motor shaft 33 starts to move relative to the armature 32 and the end plate 36, and the motor 3 thus starts to rotate. At this stage, the rotation determination unit 21 determines for the first time that the motor 3 has rotated. The friction force generated between the friction plate 34 and each of the armature 32 and the end plate 36 acts as a static friction force before the motor 3 starts to rotate (i.e., while the motor 3 is kept still by braking), but it turns into a dynamic friction force after the motor 3 starts to rotate. The torque calculated using the torque constant K_{T} and the value of the motor current supplied from the motor current supply unit 42 to the motor 3 when the rotation determination unit 21 determines for the first time that the motor 3 has rotated is based on a dynamic friction force generated during rotation of the motor 3, and therefore may not be said to be a brake torque. Rather, the torque calculated using the torque constant K_{T} and the value of the motor current supplied from the motor current supply unit 42 to the motor 3 at the time of determination processing performed one time before determination processing in which the rotation determination unit 21 determines for the first time that the motor 3 has rotated is based on a static friction force generated while the motor 3 stands still (i.e., the motor 3 has been braked by a friction force), and therefore can be said to be a “brake torque immediately before the motor 3 starts to rotate.” In the inspection mode, the rotation determination unit 21 performs determination processing every time the motor current supplied from the motor current supply unit 42 to the motor 3 is increased by a predetermined step size. In other words, the “difference of one step size subtracted from the value of the motor current supplied from the motor current supply unit 42 when it is determined for the first time that the motor 3 has rotated” corresponds to the “value of the motor current supplied from the motor current supply unit 42 to the motor 3 at the time of determination processing performed one time before determination processing in which it is determined for the first time that the motor 3 has rotated.” In view of this, in this embodiment, the brake torque calculation unit 22 calculates a brake torque, based on the torque constant of the motor 3, and the difference of at least the step size subtracted from the value of the motor current supplied from the motor current supply unit 42 when the rotation determination unit 21 determines for the first time that the motor 3 has rotated, and uses the calculated brake torque as a “brake torque immediately before the motor 3 starts to rotate.” The value subtracted from the “value of the motor current supplied from the motor current supply unit 42 when it is determined for the first time that the motor 3 has rotated” in the calculation processing by the brake torque calculation unit 22 may be preferably as large as at least a predetermined step size. Therefore, a “value equal to or larger than” the predetermined step size may be subtracted from the “value of the motor current supplied from the motor current supply unit 42 when it is determined for the first time that the motor 3 has rotated.”

Letting Iₙ be the difference of at least the step size subtracted from the value of the motor current supplied from the motor current supply unit 42 when the rotation determination unit 21 determines for the first time that the motor 3 has rotated, and K_{T} be the torque constant, the brake torque Tₙ immediately before the motor 3 starts to rotate is given by the following equation (1):

Tₙ=K_{T}×Iₙ (1)

The value of the motor current supplied from the motor current supply unit 42 when the rotation determination unit 21 determines for the first time that the motor 3 has rotated (i.e., the value of the motor current before a predetermined step size is subtracted from the motor current) is sent to the brake torque calculation unit 22. The brake torque calculation unit 22 calculates the brake torque Tₙ immediately before the motor 3 starts to rotate in accordance with, e.g., the above-mentioned equation (1).

The brake torque Tₙ calculated by the brake torque calculation unit 22 is temporarily stored in the storage unit 16. The storage unit 16 is implemented as, e.g., an electrically erasable and recordable nonvolatile memory such as an EEPROM®, or a high-speed readable and writable random access memory such as a DRAM or an SRAM. The storage unit 16 may be combined with the storage unit 23 in the brake torque measurement unit 12, and, for example, a storage area in the same storage device may be shared by the storage units 16 and 23 and used.

The brake torque drop curve calculation unit 13 reads, from the storage unit 16, brake torques measured by the brake torque measurement unit 12 in inspection modes set for different periods, and calculates a brake torque drop curve representing the relationship between the brake torque and the operating time of the brake device 2, based on the brake torques. The armature 32, the friction plate 34, and the end plate 36 wear and the brake torque of the motor 3 then drops, for every braking of the brake device 2. Accordingly, the brake torque drop curve exhibits the tendency of the brake torque to gradually decrease as the operating time of the brake device 2 increases. Calculation of a brake torque drop curve may involve the values of brake torques measured during different periods. The brake torque drop curve calculated by the brake torque drop curve calculation unit 13 is temporarily stored in the storage unit 16. The details of brake torque drop curve calculation processing by the brake torque drop curve calculation unit 13 will be described later.

The life estimation unit 14 reads, from the storage unit 16, the brake torque drop curve calculated by the brake torque drop curve calculation unit 13, and calculates an estimated life of the brake device 2, based on this brake torque drop curve. The estimated life calculated by the life estimation unit 14 is temporarily stored in the storage unit 16. The details of life estimation processing by the life estimation unit 14 will be described later.

The display unit 15 reads, from the storage unit 16, the brake torque drop curve calculated by the brake torque drop curve calculation unit 13, and displays this brake torque drop curve. The display unit 15 further reads, from the storage unit 16, the estimated life calculated by the life estimation unit 14, and displays this estimated life. The display unit 15 may be implemented as, e.g., an accessory display attached to the numerical control apparatus 100. As another example, the display unit 15 may be implemented as a separate display independent of the numerical control apparatus 100, such as a personal computer, a portable terminal, or a touch panel. As still another example, the display unit 15 may be implemented as an acoustic device that emits a sound, such as a loudspeaker, a buzzer, or a chime. As still another example, the display unit 15 may be implemented in a form displayed as printed out on, e.g., a sheet surface using a printer. Alternatively, the display unit 15 may be implemented by combining these forms together as appropriate.

The command unit 11, the rotation determination unit 21, the brake torque calculation unit 22, the brake torque drop curve calculation unit 13, and the life estimation unit 14 may be constructed in, e.g., software program form, or may be constructed as a combination of various electronic circuits and a software program. When the command unit 11, the rotation determination unit 21, the brake torque calculation unit 22, the brake torque drop curve calculation unit 13, and the life estimation unit 14 are constructed in software program form, the function of each of the above-mentioned units can be implemented by causing an arithmetic processing unit such as a DSP or an FPGA mounted in the brake inspection apparatus 1 to operate in accordance with the software program. When the brake inspection apparatus 1 is mounted in the numerical control apparatus 100 for a machine tool, the function of each of the above-mentioned units can be implemented by causing an arithmetic processing unit such as a DSP or an FPGA mounted in the numerical control apparatus 100 to operate in accordance with the software program. Alternatively, the command unit 11, the rotation determination unit 21, the brake torque calculation unit 22, the brake torque drop curve calculation unit 13, and the life estimation unit 14 may be implemented as a semiconductor integrated circuit in which a software program for implementing the function of each unit is written.

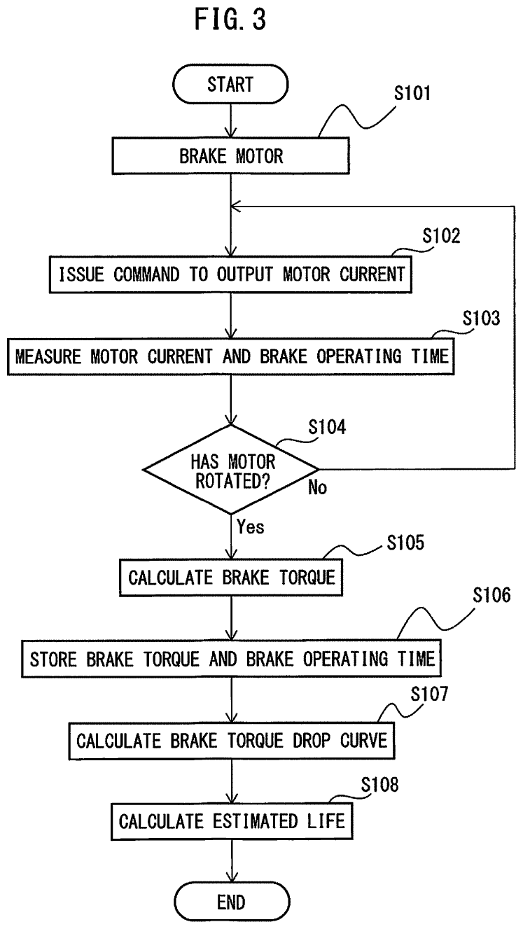

FIG. 3 is a flowchart depicting the operation sequence of the brake inspection apparatus according to the embodiment of the present disclosure.

In an inspection mode different from the normal operation mode of the brake device 2, in step S101, the command unit 11 sends an inspection command to the controller 41, which is controlled to output no brake coil current from the brake power supply device (not illustrated). With this operation, no brake coil current flows through the brake coil 35 of the brake device 2, the armature 32 is tightly pressed against the friction plate 34 by the elastic force of the spring 31, and the motor 3 is thus braked.

In step S102, the command unit 11 sends an inspection command to the controller 41, which is controlled to output a current command to gradually increase the motor current supplied to the motor 3 by a predetermined step size. With this operation, the motor current supply unit 42 supplies, to the motor 3, a motor current corresponding to the current command generated by the controller 41.

In step S103, a current measurement device measures the value of a current flowing from the motor current supply unit 42 into the current input terminal (not illustrated) of the motor 3. The brake torque drop curve calculation unit 13 measures a “brake operating time” as the time elapsing after the brake device 2 starts its operation. The brake operating time means the duration from the point of time at which the brake device 2 starts its operation for the first time after the brake device 2 is manufactured or repaired until that of the inspection mode. The brake operating time is measured by, e.g., a timer (not illustrated) mounted in the brake inspection apparatus 1 or the numerical control apparatus 100. When the brake operating time is measured by a timer implemented by the numerical control apparatus 100, the brake torque drop curve calculation unit 13 in the brake inspection apparatus 1 obtains the measured brake operating time from the numerical control apparatus 100. The brake torque drop curve calculation unit 13 may measure the number of brake operations of the brake device 2, in place of the brake operating time. In this case, the brake torque drop curve calculation unit 13 in the brake inspection apparatus 1 may preferably obtain, e.g., the number of brake operations counted by the numerical control apparatus 100.

In step S104, the rotation determination unit 21 determines whether the motor 3 has rotated. When it is not determined in step S104 that the motor 3 has rotated, the process returns to step S102, in which the command unit 11 commands the motor current supply unit 42 to output a motor current higher by a predetermined step size than the already output motor current. The processes in steps S102 to S104 are repeatedly performed until it is determined in step S104 for the first time that the motor 3 has rotated. Repeatedly performing the processes in steps S102 to S104 gradually increases the motor current supplied from the motor current supply unit 42, with the motor 3 being braked. Only after it is determined in step S104 that the motor 3 has rotated, the process advances to step S105.

In step S105, the brake torque calculation unit 22 calculates a brake torque, based on the torque constant of the motor 3, and the difference of at least the step size subtracted from the value of the motor current supplied from the motor current supply unit 42.

In step S106, to calculate a brake torque drop curve, the brake torque drop curve calculation unit 13 temporarily stores, in the storage unit 16, the brake torque calculated by the brake torque calculation unit 22, and the brake operating time, i.e., the duration from the point of time at which operation is started for the first time until that of the inspection mode.

In step S107, the brake torque drop curve calculation unit 13 calculates a brake torque drop curve representing the relationship between the brake torque and the operating time of the brake device 2, based on brake torques measured by the brake torque measurement unit 12 in inspection modes set for different periods. Calculation of a brake torque drop curve may involve the values of brake torques measured during different periods. Therefore, to calculate a brake torque drop curve by the brake torque drop curve calculation unit 13 in step S107, a series of processes in steps S101 to S106 may be preferably performed a plurality of times during different periods. The brake torque drop curve calculated by the brake torque drop curve calculation unit 13 in step S107 may be displayed on the display unit 15.

In step S108, the life estimation unit 14 calculates an estimated life of the brake device 2, based on the brake torque drop curve calculated by the brake torque drop curve calculation unit 13. The estimated life calculated by the life estimation unit 14 in step S108 may be displayed on the display unit 15.

The details of brake torque drop curve calculation processing by the brake torque drop curve calculation unit 13 and life estimation processing by the life estimation unit 14 will be described subsequently.

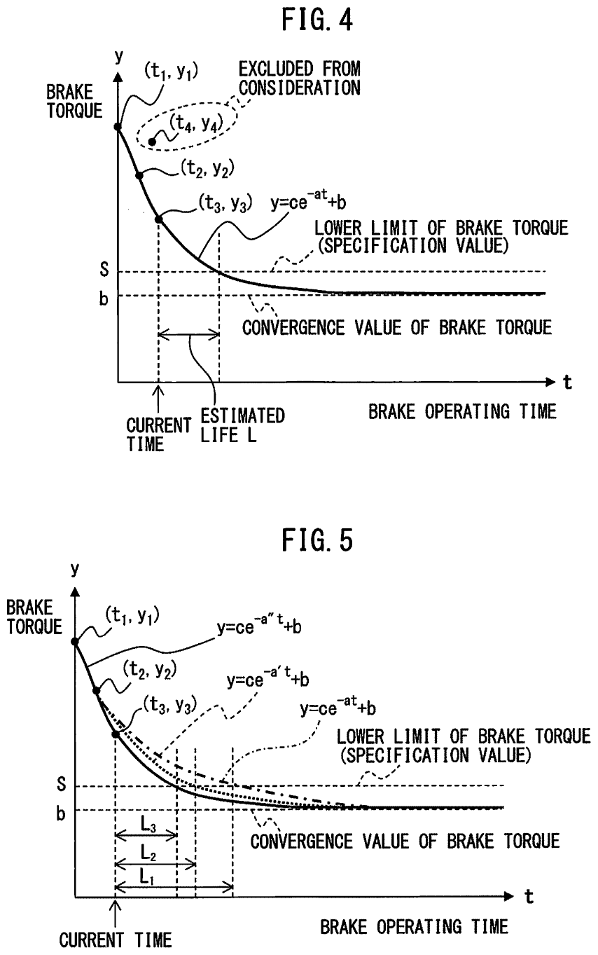

FIG. 4 is a graph for explaining brake torque drop curve calculation processing by a brake torque drop curve calculation unit and life estimation processing by a life estimation unit in the embodiment of the present disclosure. FIG. 4 represents the brake operating time on the horizontal axis t, and the brake torque on the vertical axis y.

Since the armature 32, the friction plate 34, and the end plate 36 wear and the brake torque then drops, for every braking on the motor 3 by the brake device 2, a brake torque drop curve making the brake torque lower for a longer brake operating time of the brake device 2 is obtained. In the example illustrated in FIG. 4, a brake torque drop curve is calculated assuming that the brake torque drop curve conforms to the following equation (2):

y=c·e^{-at}+b (2)

As long as the values of at least three brake torques are given, constants a, b, and c in the above-mentioned equation (2) are determined. Substituting, into the above-mentioned equation (2), each of a brake torque y₁ measured by the brake torque measurement unit 12 at brake operating time t₁, a brake torque y₂ measured by the brake torque measurement unit 12 at brake operating time t₂, and a brake torque y₃ measured by the brake torque measurement unit 12 at brake operating time t₃ yields the following equations (3)-(5):

y₁=c·e^{-at1}+b (3)

y₂=c·e^{-at2}+b (4)

y₃=c·e^{-at3}+b (5)

The brake torque drop curve calculation unit 13 calculates a brake torque drop curve by calculating the constants a, b, and c in the above-mentioned equation (2) by solving simultaneous equations presented in the above-mentioned equations (3) to (5). As is obvious from the above-mentioned equation (2), the brake torque drop curve calculated by the brake torque drop curve calculation unit 13 converges to the value b.

To obtain a brake torque drop curve based on latest data, a brake torque measured by the brake torque measurement unit 12 at the current point of time (i.e., the point of time at which the brake torque measurement unit 12 measures a latest brake torque) is preferably included in brake torques at least at three different points of time used in calculation processing by the brake torque drop curve calculation unit 13.

In the example illustrated in FIG. 4, the brake torque drop curve calculation unit 13, for example, calculates a brake torque drop curve, based on the brake torque y₁ measured by the brake torque measurement unit 12 at time t₁ at which the brake device 2 starts its operation for the first time after the brake device 2 is manufactured or repaired, the brake torque y₂ measured by the brake torque measurement unit 12 at brake operating time t₂, and the brake torque y₃ measured by the brake torque measurement unit 12 at brake operating time t₃, i.e., the current time.

When, as another example, the brake torque measurement unit 12 can measure brake torques during four or more different periods, a more precise brake torque drop curve can be calculated using three most recent brake torques including a brake torque measured at the current point of time (i.e., the point of time at which the brake torque measurement unit 12 measures a latest brake torque), among the four or more brake torques. In this case, since in step S106 of FIG. 3, the brake torque drop curve calculation unit 13 temporarily stores, in the storage unit 16, the brake operating time and the brake torque calculated by the brake torque calculation unit 22, it may preferably read the three most recent brake torques including the brake torque measured at the current point of time (i.e., the point of time at which the brake torque measurement unit 12 measures a latest brake torque), among these pieces of data stored in the storage unit 16, and calculate a brake torque drop curve in step S107.

The brake torque measured by the brake torque measurement unit 12 may take a value equal to or larger than a brake torque measured in the past. In the example illustrated in FIG. 4, a brake torque y₄ at brake operating time t₄, for example, is higher than the brake torque y₁ measured earlier than the brake torque y₄. Such data corresponds to safe-side data indicating “the brake torque is not decreased,” and therefore may be excluded from data used to calculate a brake torque drop curve by the brake torque drop curve calculation unit 13. In step S106 of FIG. 3, the brake torque drop curve calculation unit 13 temporarily stores, in the storage unit 16, the brake operating time and the brake torque calculated by the brake torque calculation unit 22, to determine whether the brake torque measured by the brake torque measurement unit 12 corresponds to safe-side data. When, for example, a certain brake torque and a brake torque measured next time are compared with each other, and it is determined as a result of comparison that the succeeding brake torque is higher than the preceding brake torque, the succeeding brake torque is excluded from data used to calculate a brake torque drop curve by the brake torque drop curve calculation unit 13. Calculating, by the brake torque drop curve calculation unit 13, a brake torque drop curve based on only brake torques that steadily continue to decrease upon exclusion of safe-side data makes it possible to calculate an estimated life of the brake device 2 based on a stricter condition, and the reliability and the safety of the life estimation result obtained by the life estimation unit 14 are therefore improved more.

The brake torque drop curve calculation unit 13, described above, calculates a brake torque drop curve based on equation (2). As a modification to this example, a brake torque drop curve may be calculated based on, e.g., the following equation (6):

y=a/t+b (6)

As long as the values of at least two brake torques are given, constants a and b in the above-mentioned equation (6) are determined. Substituting, into the above-mentioned equation (6), at least two brake torques measured by the brake torque measurement unit 12 yields the constants a and b to define a brake torque drop curve. As is obvious from the above-mentioned equation (6), the brake torque drop curve calculated by the brake torque drop curve calculation unit 13 converges to the value b.

As another example, as long as the values of at least four brake torques are given, the brake torque drop curve calculation unit 13 may calculate a brake torque drop curve based on the least squares method.

The brake torque drop curve calculated in the aforementioned way is displayed on the display unit 15. The operator can precisely and easily know the tendency of the brake torque of the mechanical brake device 2, which performs braking by a friction force, to drop, by referring to the brake torque drop curve displayed on the display unit 15.

The brake torque drop curve calculated in the aforementioned way can be used to calculate an estimated life of the brake device 2 by the life estimation unit 14. The state in which the brake torque has dropped to be as low as a lower limit or less, which serves as a criterion for ensuring a certain brake performance, is generally recognized as the “state in which the brake device has come to the end of its life,” or the “state in which the brake device has broken down.” As illustrated in, e.g., FIG. 4, the life estimation unit 14 compares the brake torque drop curve with a lower limit (specification value) S of the brake torque, calculates the point of time at which the brake torque drop curve falls below the lower limit of the brake torque as the “point of time at which the brake device 2 comes to the end of its life,” and calculates the difference between this point of time and the current point of time (i.e., the point of time at which the brake torque measurement unit 12 measures a latest brake torque) as an estimated life L. As the lower limit S of the brake torque serving as a criterion for ensuring a certain brake performance, a value specified in the specification of the brake device 2 in advance, for example, may be used, or an arbitrary value input to the brake inspection apparatus 1 via an input device (not illustrated) by the operator may be used. Since, however, the brake torque drop curve calculated by the brake torque drop curve calculation unit 13 converges to a certain convergence value b, the lower limit S of the brake torque serving as a criterion for ensuring a certain brake performance is desirably set to a value larger than the convergence value b of the brake torque drop curve. For example, as the lower limit S of the brake torque is set to a larger value, the estimated life L becomes farther shorter than an actual life, and the trouble in which the brake device 2 actually comes to the end of its life contrary to expectation can be more reliably prevented.

The estimated life L calculated in the aforementioned way is displayed on the display unit 15. Although an example of the display unit 15 has already been given above, when, for example, the display unit 15 is implemented as a display, the estimated life L can be displayed on the display using a text or an image. The operator can precisely and easily know the life of the brake device 2 by referring to the estimated life L displayed on the display unit 15. The display unit 15 may even notify the operator of information for recommending part replacement or maintenance and servicing of the brake device 2, based on the estimated life calculated by the life estimation unit 14. Since the display unit 15 allows the operator to know the estimated life of the brake device 2, the brake device 2 can be replaced before it gets inoperable, and an alarm stop (emergency stop) of the machine equipped with the brake device 2 can be prevented. Part replacement or maintenance and servicing of the brake device 2 can be performed during an appropriate period such as the nonoperating time of the machine equipped with the brake device 2, and inventory control of replacement parts for the brake device 2 can even be optimized. Alternatively, as the content to be notified by the display unit 15, an operation state that significantly affects the life of the brake device 2 obtained upon calculation of an estimated life may be sent together. This allows the operator to take a measure to change the operation state that affects the life of the brake device 2. The designer can take, e.g., a measure to improve the environment surrounding the machine equipped with the brake device 2 or a measure to change the operation conditions of the machine equipped with the brake device 2, to keep the life of the brake device 2 from shortening.

The brake torque drop curve calculation unit 13 may calculate a brake torque drop curve, based on brake torques measured by the brake torque measurement unit 12, and a parameter unique to the machine equipped with the brake device 2. Several modes for calculating a brake torque drop curve by taking into consideration a parameter unique to the machine equipped with the brake device 2 will be listed below.

In the first mode for calculating a brake torque drop curve by taking into consideration a parameter unique to the machine, the machine equipped with the brake device 2 serves as, e.g., a cutting machine. When the brake device 2 is placed in a machining chamber of the cutting machine, a cutting fluid enters the gap between the armature 32 and the friction plate 34 or that between the end plate 36 and the friction plate 34 in the brake device 2, thus lowering the brake torque. Generally, the larger the amount of entrance of the cutting fluid, the lower the brake torque. In view of this, in the first mode, the brake torque drop curve calculation unit 13 calculates a brake torque drop curve, based on brake torques measured by the brake torque measurement unit 12, and the amount of entrance of a cutting fluid into the brake device 2 placed in the machining chamber of the cutting machine. FIG. 5 is a graph for explaining brake torque drop curve calculation processing by the brake torque drop curve calculation unit and life estimation processing by the life estimation unit, which take into consideration the amount of entrance of a cutting fluid for a cutting machine into the brake device, in the embodiment of the present disclosure.

When, for example, a brake torque drop curve is calculated in accordance with equation (2), the degree of decrease in brake torque of the brake torque drop curve changes depending on the value of a coefficient a. For example, in equation (2), letting a be a coefficient when the amount of entrance of a cutting fluid into the brake device is zero, a′ be a coefficient when the amount of entrance of a cutting fluid into the brake device is moderate, and a″ be a coefficient when the amount of entrance of a cutting fluid into the brake device is large, the brake torque drop curve corresponding to each amount of entrance is given by the following equations (7) to (9), as illustrated in FIG. 5:

y=c·e^{-at}+b (7)

y=c·e^{-a′t}+b (8)

y=c·e^{-a″t}+b (9)

Referring to FIG. 5, the brake torque drop curve presented in equation (7) when the amount of entrance of a cutting fluid into the brake device 2 is zero is indicated by a bold alternate long and short dashed line, the brake torque drop curve presented in equation (8) when the amount of entrance of a cutting fluid into the brake device 2 is moderate is indicated by a bold dotted line, and the brake torque drop curve presented in equation (9) when the amount of entrance of a cutting fluid into the brake device 2 is large is indicated by a bold solid line. FIG. 5 reveals that as long as the coefficient a in equation (2) is set in accordance with the amount of entrance of a cutting fluid into the brake device 2, a brake torque drop curve corresponding to the amount of entrance of a cutting fluid into the brake device 2 can be calculated. When an estimated life is calculated by comparing each brake torque drop curve with the lower limit (specification value) S of the brake torque, the estimated life when the amount of entrance of a cutting fluid into the brake device 2 is zero is represented as L₁, the estimated life when the amount of entrance of a cutting fluid into the brake device 2 is moderate is represented as L₂, and the estimated life when the amount of entrance of a cutting fluid into the brake device 2 is large is represented as L₃. In other words, the larger the amount of entrance of a cutting fluid into the brake device 2, the shorter the estimated life. Accordingly, an estimated life corresponding to the amount of entrance of a cutting fluid into the brake device 2 can be calculated by changing, as appropriate, the coefficient a in equation (2) used to calculate a brake torque drop curve by the brake torque drop curve calculation unit 13. For example, pieces of data concerning the actual brake torque and life of the brake device 2 mounted in the cutting machine are obtained, accumulated, converted into a database upon being associated with the above-mentioned amount of entrance of the cutting fluid, and stored in the storage unit 16. The relationships between the amount of entrance of a cutting fluid into the brake device 2 and the coefficients a, a′, and a″ in equation (2), for example, are converted into a database and stored in the storage unit 16. In actually operating the cutting machine equipped with the brake device 2, the amount of entrance of a cutting fluid into the brake device 2 placed in the machining chamber of the cutting machine may be preferably measured, and information corresponding to this amount of entrance may be preferably retrieved from the database stored in the storage unit 16, and used for brake torque drop curve calculation by the brake torque drop curve calculation unit 13 and life estimation by the life estimation unit 14. As another example, a brake torque is measured in advance by the brake torque measurement unit 12 after different amounts of cutting fluids are intentionally made to enter the brake device 2 in a test operation of the cutting machine, and the relationship between the amount of entrance of the cutting fluid and the coefficient a is converted into a database and stored in the storage unit 16, in advance. In actually operating the cutting machine, the amount of entrance of a cutting fluid into the brake device 2 may be preferably measured, and a coefficient a corresponding to the measured amount of entrance of the cutting fluid may be preferably retrieved from the database stored in the storage unit 16, and used for brake torque drop curve calculation by the brake torque drop curve calculation unit 13 and life estimation by the life estimation unit 14.

The case where the brake torque drop curve conforms to equation (2) has been taken as an example in the above-described first mode, but this mode is similarly applicable when a brake torque drop curve is calculated in accordance with equation (6) or the least squares method.

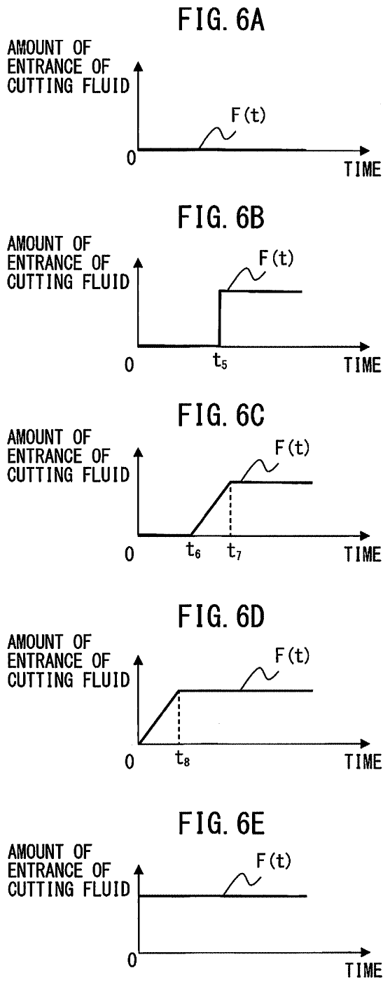

In the second mode for calculating a brake torque drop curve by taking into consideration a parameter unique to the machine, a brake torque drop curve is calculated in accordance with a seal performance representing the degree of entrance of a liquid or a gas from the exterior into a housing accommodating the brake device 2 mounted in the machine. Depending on the shape or the use environment of a housing that may involve a seal, the material and the shape of the seal are determined, and the pattern and the degree of progress of deterioration vary. FIGS. 6A to 6E are graphs illustrating exemplary deteriorations of a seal mounted in a housing. FIG. 6A exemplifies the case where the seal does not deteriorate. FIG. 6B exemplifies the case where the seal is broken at time t₅, and reveals that the amount of entrance F(t) of a cutting fluid from the exterior into the housing suddenly rises upon the breakage of the seal at time t₅. FIG. 6C exemplifies the case where the seal starts to gradually deteriorate at time t₆ and is completely broken at time t₇, and reveals that the amount of entrance F(t) of a cutting fluid from the exterior into the housing starts to gradually rise at time t₆ and the seal completely loses its function at time t₇. FIG. 6D exemplifies the case where the seal starts to gradually deteriorate immediately after the start of use of the housing as newly manufactured, and is completely broken at time t₈, and reveals that the amount of entrance F(t) of a cutting fluid from the exterior into the housing starts to gradually rise at a stage earlier than that in FIG. 6C and the seal completely loses its function at time t₈. FIG. 6E exemplifies the case where the housing as newly manufactured exhibits no seal performance from the beginning.

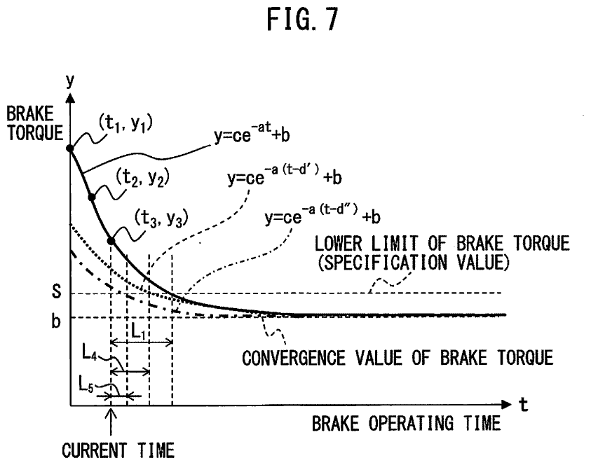

The brake torque drop curve calculation unit 13 calculates a brake torque drop curve, based on brake torques measured by the brake torque measurement unit 12, and the seal performance representing the degree of entrance of a liquid or a gas from the exterior into the housing accommodating the brake device 2 mounted in the machine. FIG. 7 is a graph for explaining brake torque drop curve calculation processing by the brake torque drop curve calculation unit and life estimation processing by the life estimation unit, which take into consideration the seal performance of a housing accommodating the brake device, in the embodiment of the present disclosure.

When, as illustrated in FIG. 6A, the seal does not deteriorate, the brake torque drop curve conforms to equation (2) and is indicated by a bold solid line in FIG. 7. In this case, the estimated life is calculated by the life estimation unit 14 as L₁.

When, as illustrated in FIG. 6B, the seal is broken at time t₅, since the life is shorter than when, as illustrated in FIG. 6A, the seal does not deteriorate, the brake torque drop curve calculation unit 13 calculates a brake torque drop curve in accordance with, e.g., the following equation (10) upon substitution of “t−d′” for “t” in equation (2):

y=c·e^{-a(t-d′)}+b (10)

The brake torque drop curve presented in equation (10) is indicated by a bold dotted line. In this case, the estimated life is calculated by the life estimation unit 14 as L₄ (<L₁).

When, as illustrated in FIG. 6E, the housing as newly manufactured exhibits no seal performance from the beginning, since the life is farther shorter than when, as illustrated in FIG. 6B, the seal is broken at time t₅, the brake torque drop curve calculation unit 13 calculates a brake torque drop curve in accordance with, e.g., the following equation (11) upon substitution of “t−d” for “t” in equation (2):

y=c·e^{-a(t-d″)}+b (11)

for d″>d′

The brake torque drop curve presented in equation (11) is indicated by a bold alternate long and short dashed line. In this case, the estimated life is calculated by the life estimation unit 14 as L₅ (<L₄).

In this manner, the poorer the seal performance representing the degree of entrance of a liquid or a gas from the exterior into the housing accommodating the brake device 2 mounted in the machine, the shorter the estimated life calculated by the life estimation unit 14. Accordingly, an estimated life corresponding to the seal performance of the housing accommodating the brake device 2 can be calculated by changing, as appropriate, the variable “t” representing the brake operating time in equation (2) used to calculate a brake torque drop curve by the brake torque drop curve calculation unit 13. Depending on the shape or the use environment of a housing that may involve a seal, the material and the shape of the seal are determined, and the pattern and the degree of progress of deterioration vary. In view of this, pieces of data concerning the actual brake torque and life of the brake device 2 accommodated in housings equipped with seals having various materials and shapes are obtained, accumulated, converted into a database upon being associated with the seals, and stored in the storage unit 16. The relationships between the seal performance and the coefficients d′ and d″ in equations (10) and (11), for example, are converted into a database and stored in the storage unit 16. In actually operating the machine equipped with the brake device 2, information corresponding to the seal mounted in the housing accommodating the brake device 2 may be preferably retrieved from the database stored in the storage unit 16, and used for brake torque drop curve calculation by the brake torque drop curve calculation unit 13 and life estimation by the life estimation unit 14.

The case where the brake torque drop curve conforms to equation (2) has been taken as an example in the above-described second mode, but this mode is similarly applicable when a brake torque drop curve is calculated in accordance with equation (6) or the least squares method.

In this manner, calculating a brake torque drop curve by taking into consideration a parameter unique to the machine equipped with the brake device 2 makes it possible to precisely and easily obtain the tendency of the brake torque to drop and the estimated life, in accordance with the use environment of the brake device 2.

According to one aspect of the present disclosure, information on the tendency of the brake torque of a mechanical brake device, which performs braking by a friction force, to drop can be precisely and easily obtained.

1. A brake inspection apparatus for inspecting a brake device that brakes a motor by pressing, by an elastic force of a spring, an armature against a friction plate connected to a motor shaft, and cancels braking on the motor by separating the armature from the friction plate by an electromagnetic force generated by supplying a brake coil current to a brake coil, the apparatus comprising:
a command unit configured to, in an inspection mode, command the brake device to brake the motor, and further command a motor current supply unit to gradually increase a motor current supplied to the motor by a predetermined step size;
a brake torque measurement unit configured to measure a brake torque immediately before the motor starts to rotate, when the motor current supplied from the motor current supply unit is gradually increased based on a command from the command unit; and
a brake torque drop curve calculation unit configured to calculate a brake torque drop curve representing a relationship between the brake torque and an operating time of the brake device, based on the brake torque comprising a plurality of brake torques measured by the brake torque measurement unit in the inspection mode comprising a plurality of inspection modes set for different periods.

2. The brake inspection apparatus according to claim 1, wherein the brake torque measurement unit comprises:
a rotation determination unit configured to determine whether the motor has rotated, every time the motor current supplied from the motor current supply unit is increased by the step size, based on the command from the command unit in the inspection mode; and
a brake torque calculation unit that calculates the brake torque, based on a torque constant of the motor, and a difference of at least the step size subtracted from a value of the motor current supplied from the motor current supply unit when the rotation determination unit determines for a first time that the motor has rotated.

3. The brake inspection apparatus according to claim 1, wherein the brake torque drop curve calculation unit calculates the brake torque drop curve, based on the plurality of brake torques measured by the brake torque measurement unit, and a parameter unique to a machine equipped with the brake device.

4. The brake inspection apparatus according to claim 3, wherein
the machine comprises a cutting machine, and
the brake torque drop curve calculation unit calculates the brake torque drop curve, based on the plurality of brake torques measured by the brake torque measurement unit, and an amount of entrance of a cutting fluid into the brake device placed in a machining chamber of the cutting machine.

5. The brake inspection apparatus according to claim 3, wherein the brake torque drop curve calculation unit calculates the brake torque drop curve, based on the plurality of brake torques measured by the brake torque measurement unit, and a seal performance representing a degree of entrance of one of a liquid and a gas from an exterior into a housing accommodating the brake device mounted in the machine.

6. The brake inspection apparatus according to claim 1, further comprising a life estimation unit configured to calculate an estimated life of the brake device, based on the brake torque drop curve calculated by the brake torque drop curve calculation unit.

7. The brake inspection apparatus according to claim 1, further comprising a display unit configured to display the brake torque drop curve calculated by the brake torque drop curve calculation unit.

8. A numerical control apparatus for a machine tool, the apparatus comprising the brake inspection apparatus according to claim 1.
